(19) United States
(12) Patent Application Publication
(10) Pub. No.: US 2019/0155359 A1
(43) Pub. Date: May 23, 2019

(54) METHOD FOR AUTOMATICALLY MANAGING THE ELECTRICITY CONSUMPTION OF A SERVER FARM

(71) Applicant: BULL SAS, Les Clayes-sous-Bois (FR)

(72) Inventors: Liana BOZGA, Meylan (FR); Philippe LACHAMP, Sassenage (FR); Jean-Olivier GERPHAGNON, Seyssins (FR)

(21) Appl. No.: 15/540,900

(22) PCT Filed: Dec. 28, 2015
(86) PCT No.: PCT/EP2015/081279

§ 371 Date: Jun. 29, 2017

(30) Foreign Application Priority Data
Dec. 30, 2014 (FR) 1463444

(51) Int. Cl. G06F 1/3206; G06F 1/18; G06F 1/3287; G06F 9/50

(52) U.S. Cl. CPC G06F 1/3206; G06F 9/5094; G06F 1/3287; G06F 1/189

(57) ABSTRACT

A method for automatically managing the electricity consumption of a server farm including a plurality of nodes, the method including measuring an instantaneous consumption of the server farm; acquiring an instantaneous consumption limit; predicting a future consumption according to a function of at least the instantaneous consumption measurement; and, when the prediction is higher than the acquired instantaneous limit, selecting at least one node and electrically switching off the at least one selected node.

### TECHNICAL FIELD OF THE INVENTION

The invention relates to a method for managing the electricity consumption of a server farm.

The term server farm in the framework of this application means any set of servers managed in a centralised manner. This in particular concerns high performance computing (HPC).

### PRIOR ART

In a high performance computing (HPC) environment, the energy consumption is a preponderant criterion for at least three reasons:

the available power has to be taken into account in order to avoid collapsing the power supply structure and therefore the computer;

the thermal dissipation capacities have to be taken into account in order to avoid the risk of damaging the computer via heating;

finally the associated cost can exceed a million euros per year (current metric based on computing power of about 1 MW/PFlops).

In this context it is important to ensure that the maximum energy consumption tolerated (i.e. by the computer in place limiting the number of MWs that can be used, or in order to limit and control the energy bill) is complied with.

To do this, mechanisms exist in order to position computing servers on power-off, on suspend or to reduce its use of energy (idle mode or reduction in the CPU frequency, etc.). However, these power-offs or these changes in state have to be managed in order to ensure optimal operation of the computer (maximum performance within the given energy envelope).

This concern for not exceeding the “authorised” maximum power (either by a physical constraint or by an economic constraint) must be able to be managed in a very reactive manner (reaction of a magnitude of a millisecond) and therefore cannot easily be processed at the software level (i.e. several thousands of pieces of equipment to be processed in parallel). It is therefore necessary to process (at least partially) consumption peaks via mechanisms of the “circuit breaker” type.

Circuit breakers are very fast and cut off the power supply of a group of nodes. This is however a reactive approach, the over-consumption of energy has already started. In addition in order to put the cut-off nodes back on line, a resetting that is very often manual has to be carried out.

The solutions of prior art therefore do not allow for a fine management of the consumption of a computer and in particular do not make it possible to follow a consumption setpoint value.

### DISCLOSURE OF THE INVENTION

The invention aims to overcome all or a portion of the disadvantages of the prior art identified hereinabove, and in particular to propose means for making it possible to follow a consumption setpoint value without exceeding it.

In this design, an aspect of the invention relates to a method for automatically managing the electricity consumption of a server farm comprising a plurality of nodes characterised in that the method comprises the following steps:

measuring an instantaneous consumption of the server farm;

acquiring an instantaneous consumption limit;

predicting a future consumption according to a function of at least the instantaneous consumption measurement;

if the prediction is higher than the acquired instantaneous limit then:

selecting at least one node

electrically switching off the at least one selected node.

In addition to the main characteristics that have just been mentioned in the preceding paragraph, the method/device according to the invention can have one or more additional characteristics among the following, taken individually or according to the technically permissible combinations:

the number of nodes selected is a function of the difference between the predicted consumption and the instantaneous consumption limit;

the method is implemented before an allocation of resources, with the resources that have to be allocated being used as a parameter of the function for predicting the future consumption;

the method is implemented according to a schedule;

the nodes are assigned to processing, with the processing being ranked according to at least two categories, with the at least one node being selected according to the category of processing that it runs;

the nodes are pre-ranked into at least two groups;

the at least one node is selected from a predetermined group;

in order to select the at least one node an entire predetermined group is selected;

the at least one node is selected among the nodes that have a predetermined status.

The invention also relates to a digital storage device that comprises a file corresponding to instruction codes that implement the method according to a possible combination of the preceding characteristic.

The invention also relates to a device that implements the method according to a possible combination of the preceding characteristics.

### BRIEF DESCRIPTION OF THE FIGURES

Other characteristics and advantages of the invention shall appear when reading the following description, in reference to the annexed figures, which show:

FIG. 1: an illustration of means allowing for the implementation of the invention;

FIG. 2: an illustration of the steps of the method according to the invention.

For increased clarity, identical or similar elements are marked with identical reference signs in all of the figures.

The invention shall be understood better when reading the following description and when examining the figures that accompany it. The latter are presented for the purposes of information and in no way limit the invention.

### DETAILED DESCRIPTION OF AN EMBODIMENT

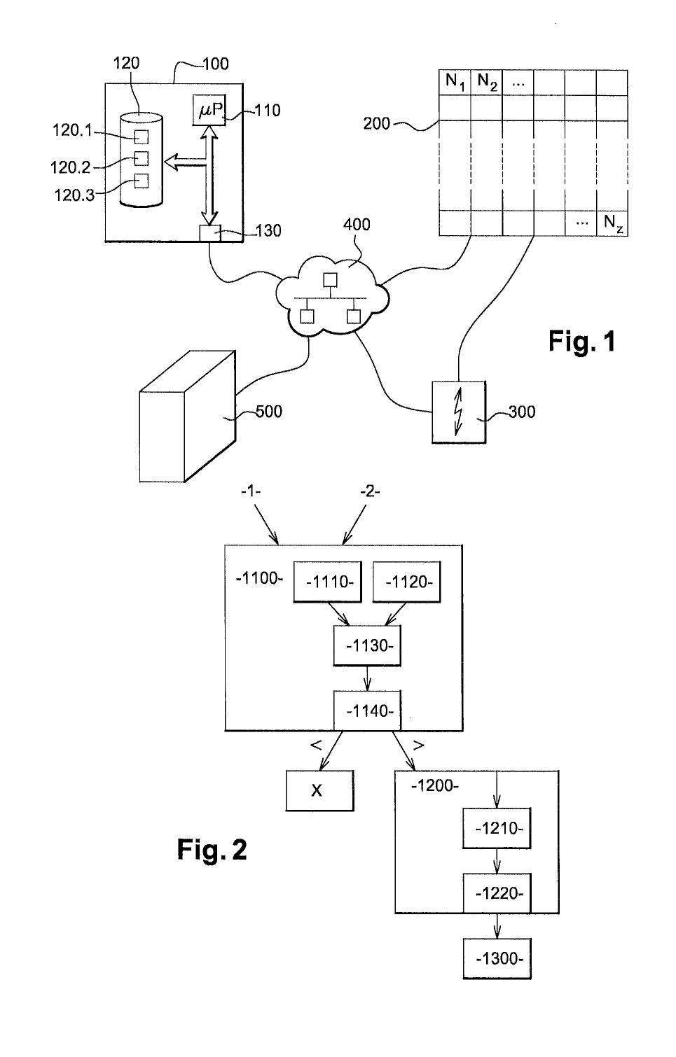

FIG. 1 shows a supervision server device 100. The supervision server comprises:

a microprocessor 110;

means for storing 120, for example a hard drive whether it is local or remote, whether it is single or in a grid (for example RAID);

a communication interface 130, for example a communication card according to the Ethernet protocol. Other protocols can be considered such as “Fibre Channel” or Infini Band.

The microprocessor 110 of the supervision server, the means 120 for storage of the supervision server and the communication interface 130 of the supervision server are interconnected by a bus 150.

When an action is lent to a device the latter is in fact carried out by a microprocessor of the device controlled by instruction codes recorded in a memory of the device. If an action is lent to an application, the latter is indeed carried out by a microprocessor of the device in a memory of which the instruction codes that correspond to the application are recorded. When a device, or an application emits a message, this message is emitted via a communication interface of said device or of said application.

FIG. 1 shows that the means 120 for storage of the supervision server 100 comprise:

a zone 120.1 comprising instruction codes that correspond to the implementation of the invention;

a zone 120.2 of a farm database, or node management database, that contains the information on the nodes that the server farm contains supervised by the supervision server 100;

a zone 120.3 comprising a description of node groups. Such a description comprises at least one node identifier set. A node identifier is, for example, an address over a network to which the node is connected, or an identifier in a node management database.

FIG. 1 shows a server farm 200. The server farm 200 comprising a number Z of nodes. In this description the server farm 200 is supervised by the supervision server 100.

FIG. 1 shows a power supply unit 300 that corresponds to an electrical cabinet 300 from which the power is distributed in the server farm 200.

FIG. 1 shows a network 400 that makes it possible to interconnect the supervision server 100, the server farm 200 and the power supply cabinet 300.

In practice it is also the electrical cabinet 300 that powers the supervision server 100 and the network 400.

FIG. 1 shows a calendar server 500, with the calendar server 500 being interconnected with the supervision server 100 via at least the network 400. The calendar server 500 delivers, when it is queried a power limit, i.e. a value that represents a maximum consumption. This value can be associated with one or several dates in such a way as to specify during which time interval the delivered limit is valid.

In an alternative, the calendar server can be replaced with a zone in the means for storing of the supervision server 100. Such a zone is, for example, structured like a table in order to associate intervals of time and power limits.

FIG. 2 shows a step 1100 of evaluating the necessity of adapting the consumption of the server farm 200. This step can occur in at least two circumstances:

first case: the supervision server allocates resources for the purposes of executing a new job,

second case: a scheduling of the evaluation in order to best follow the changes in a power limit setpoint.

FIG. 2 shows that the step 1100 comprises a sub-step 1110 of measuring the instantaneous consumption of the server farm 200. In the sub-step 1110 of measuring an instantaneous consumption, the supervision server 100 queries the power supply cabinet 300 in order to know the power that it is currently delivering. FIG. 2 shows that the step 1100 comprises a sub-step 1120 of acquiring an instantaneous consumption limit. In the sub-step 1120 of acquiring an instantaneous consumption limit the supervision server 100 queries the calendar server 500 in order to know the current limit, i.e. on the date in question, the power that the server farm 200 can consume. In an alternative the method for acquiring the limit includes the possibility of specifying a date. A limit that corresponds to the specified date is then obtained.

At the end of the step 1110 of measuring an instantaneous consumption and of the step 1120 of acquiring an instantaneous consumption limit the supervision server 100 passes to the sub-step 1130 of predicting a future consumption. The step 1130 depends on the case that provoked the execution of the step 1100 of evaluating the necessity of adapting the consumption.

In the first case the supervision server 100 is in the process of allocating resources for the purpose of running a new job. The supervision server 100 knows the characteristics of this new job, and in particular the number of nodes required for said execution, The server is therefore able to calculate what the consumption of the farm will be once the new job is running. This is the sum of the instantaneous consumption and of the estimated consumption for the execution of the new job. The supervision server 100 as such obtains a predicted consumption that corresponds to the first case.

The first case can be somewhat more complex by taking into account, for example, the jobs that are going to end.

In the second case there is no new job to schedule, In this case the predicted consumption is the instantaneous consumption measured.

In the first and second cases the acquisition of the limit can be done for a date that is slightly in the future. In the second case, this slight date in the future can be, for example, the half-period for scheduling.

At the end of the sub-step 1130 of predicting, the supervision server 100 has therefore produced a consumption prediction.

From the sub-step 1130 of predicting the supervision server 100 passes to a sub-step 1140 of confronting the prediction with the acquired limit. If the prediction is less than the acquired limit, control then passes to the step X of the end of power management. If the prediction is higher than the acquired limit, then control passes to a step 1200 of limiting the consumption of the farm.

The step 1200 comprises a sub-step 1210 of calculating the number of nodes to be switched off in order to not exceed the acquired limit. This number of nodes is a function of the difference between the prediction and the acquired limit.

Once the number of nodes to be switched off is known control passes to a step 1220 of selecting a number of nodes that corresponds to the number calculated in the preceding step. There are several strategies for this selection.

A first strategy consists in choosing a group of nodes from the groups of nodes described in the zone 120.3 of describing groups of nodes. The group chosen must satisfy at least two criteria:

comprise a number of nodes at least equal to the number of nodes calculated in the sub-step 1210 of calculating the number of nodes,

correspond to powered nodes.

In this first strategy, once the group is selected it is possible, in an alternative, to choose only the number of nodes required and not the entire group.

A second strategy consists in choosing nodes from those described by the node management database as being in an “idle” state, i.e. waiting to be allocated. Note here that in a server farm with a high performance vocation, the nodes, and their components, are never in a sleep state in order to guarantee the fastest start-up possible. This results in significant consumption where idle.

A third strategy consists in choosing nodes from those that are running jobs that have been identified as non-priority. This third strategy is implemented effectively by using several job management queues, in particular by using a management queue dedicated to non-priority jobs. The selecting of the corresponding nodes is thus facilitated.

It is possible to use several of these strategies at the same time, according to the number of nodes to be selected or according to a predetermined schedule.

Once the nodes are selected, control passes to a step 1300 of turning off selected nodes. This turning off is carried out, through the emission of a message, for example IPMI, to the selected nodes.

It is as such possible, with the invention, to prevent exceeding a consumption limit setpoint. The invention also makes it possible to follow such a setpoint as close as possible.

1. A method for automatically managing an electricity consumption of a server farm comprising a plurality of nodes, the method comprising:
measuring an instantaneous consumption of the server farm;
acquiring an instantaneous consumption limit;
predicting a future consumption according to a function of at least the instantaneous consumption measurement;
when the prediction is higher than the acquired instantaneous limit then:
selecting at least one node, and
electrically switching off the at least one selected node.

2. The method for automatic management according to claim 1, wherein a number of nodes selected is a function of the difference between the predicted consumption and the instantaneous consumption limit.

3. The method for automatic management according to claim 1, wherein the method is implemented before an allocation of resources, with the resources that have to be allocated being used as a parameter for the function of predicting future consumption.

4. The method for automatic management according to claim 1, wherein the method is implemented according to a schedule.

5. The method for automatic management according to claim 1, wherein the nodes are assigned to processing, with the processing being ranked according to at least two categories, with the at least one node being selected according to the category of processing that the at least one node runs.

6. The method for automatic management according to claim 1, wherein the nodes are pre-ranked into at least two groups.

7. The method for automatic management according to claim 4, wherein the at least one node is selected from a predetermined group.

8. The method for automatic management according to claim 4, wherein in order to select the at least one node the entire predetermined group is selected.

9. The method for automatic management according to claim 1, wherein the at least one node is selected among the nodes that have a predetermined status.

10. A non-transitory digital storage device comprising a file corresponding to instruction codes that implement the method according to claim 1.

11. A non-transitory device implementing the method according to claim 1.
